(19) United States
(12) Patent Application Publication
(10) Pub. No.: US 2023/0374409 A1
(43) Pub. Date: Nov. 23, 2023

(54) LEAF-IN-SPLIT-STICK CANDLE WICK

(71) Applicant: Adam James Smith, Sandusky, OH (US)

(72) Inventor: Adam James Smith, Sandusky, OH (US)

(21) Appl. No.: 17/663,807

(22) Filed: May 17, 2022

(51) Int. Cl. C11C 5/00; C11C 5/02

(52) U.S. Cl. CPC C11C 5/006; C11C 5/02

(57) ABSTRACT

One embodiment of a wooden [1, (A), and (B),] wick composition with the second and only other component, flower petal material [2, 2(A), 2(B)]. The two wood sides [1, (A), and (B),] fix leaf or flower petal between them upright with means of permanently and stably sustaining this position (3) as pictured in the Drawings. Other embodiments are described, though represented with split maple stick and rose petals in all Drawings/Figures.

### CROSS-REFERENCE TO RELATED APPLICATIONS

This application claims the benefit of provisional patent application U.S. 63/258,595, filed on May 17, 2021, by the present inventor, for THE LEAF-IN-SPLIT-STICK CANDLE WICK, which is incorporated by reference in its entirety.

### BACKGROUND

### Technical Field

This application relates to wicks and more specifically candle wicks.

### Prior Art

The following is a tabulation of some prior art that presently appears relevant:

U.S. Patents

| Patent Number | Kind Code | Issue Date | Patentee |
|---|---|---|---|
| US 20050037308 | A1 | (Filed) 2004 Jan. 15 | Decker, DayNa M. |

Foreign Patent Documents

| Foreign | | | | |
|---|---|---|---|---|
| Document | Country | Kind | | |
| No. | Code | Code | Pub. Dt. | App or Patentee |
| 215050043 | CN | (U) | 2021 Dec. 7 | Wang Liqun; |
| | | | | Zhu Xuwei |
| 02015125982 | W | A1 | 2015 Aug. 27 | Bae |
| | | | | Yeonggeun |
| 313586 | TW | (B) | 1997 Aug. 21 | Tzeng, Ian |

### NONPATENT LITERATURE DOCUMENTS

https://cordialcrafts.com/can-you-put-flower-petals-in-candles/ Copyright 2021, Cordialcrafts

### FIELD OF THE INVENTION

The history of candles and candle wicks is indeed expansive, having gone on for up to 40,000 years (NPL Cite No.⁴). Crude by today's standard at the beginning, candles now are innovated to a state of quality. Although, they are not at the level of excellence achievable.

Wicks braided from natural fibers like cotton (U.S. Pat. No. 6,699,034 B2) or made from other natural materials (patent TW 313586 B), with cores made from bamboo or the like (patent CN 215050043 U), are favorable selections for candle making. These pair well with the selection available of plant-based waxes. Essential oils added for fragrance may burn without emitting toxins.

As well, however, there are the problematic areas of the candle industry. Paraffin wax is made from crude petroleum and is known to emit smoke (NPL Cite No.⁵). Paraffin is also considered toxic when burned (NPL Cite No.⁷ and No.⁸). There is little regulation, hence candle wicks, and fragrance oils used in candle making, even “essential oils”—supposedly pure—can possibly emit toxins (NPL Cite No.⁹). It is hard to distinguish what candles and candle making products are safe, and in turn difficult to find safe candles and supplies for making them on the market.

Cotton wicks, as with all wicks, emit smoke at least when they are extinguished. I will debate over this smoke plume. Essentially, I would call it unpleasant (though some may disagree), rousting my suspicion of toxicity. Also, to fragrance cotton wick candles, a fragrant additive must be used in the wax, or else the wick be treated or infused with one. Ultimately, they are suitable in my opinion, just in need of some reservation given a good alternative.

The fragrant additives for wax available are not, “whole.” They have all been processed at least somewhat. Essential and fragrance oils flood the market. They take more resources to produce than whole fragrance elements which are direct: resources themselves, already produced, and ready to use. Oil and other additives leave a sense of wonder: what they exactly are, and how they came to be.

Wooden wicks (e.g., planar) come close to covering the inadequacies of other wicks . . . Although, these may not suffice as stand-alone aromatherapy, without fragrance additives. Also, the source of wood can be brought into question: how many resources were used to produce it (power saws, etc.); whether it was treated other than drying; what origin did it derive from (possibly deforestation)?

This is the candle industry. I consider it expansive, and glorious; however, in need of relief. Finding good candles for purchase has always been a frustrating task to me.

### DESCRIPTION OF RELATED ART

The applicant should admit that NFL Cite No.¹⁰ does border on prima facie. Otherwise, nothing relevant has been discovered.

NFL Cite No.¹⁰, is an online magazine article, or, ‘blog,’ regarding candle making and as well flower petals.

Said NFL Cite No.¹⁰ most specifically advances closest without describing prima facie in Paragraph 35-Paragraph 36:

Para. 36, NFL No.¹⁰: “You may choose to include a small amount of dried flower petals in your candle using a wick, or you may want to keep it all intact and just sprinkle a little of the petals on the candle using a sprinkling tin.”

The applicant does not believe prima facie is achieved here, for the quotation seems construable to include only prior art and, “judicial exception.” Therefore, the applicant, with their invention applied for, does not claim or specify relevant prior art from NPL Cite No.¹⁰.

Para. 35, NPL Cite No.¹⁰: “So how do you put flowers in candles? The best way is to use a wick or plug to hold your flower petals in place, and a floral container such as a flower pot or cookie jar to put your arrangement into.”

The applicant believes this is only regarding decor, and, does not construe as similar to the claimed invention of this application.

The types of wicks found, as in CPC Classification Code 5/00, include: fiber wicks (made often of cotton or synthetic material), and fiber wicks with other elements infused in or onto them; wood wicks (usually, ‘planar’), and wood wicks with coating material; and composite wicks (which can be fiber and wood wicks joined together or wicks with more than one layer of composition).

What most exonerated the L.I.S.T Candle Wick was my searches of patents (U.S. and foreign) for the terms, “Flower,” and, “Leaf.” No results whatsoever listed any wicks with elements of either. As well classification searches, and all search result lists pored through by the applicant themselves, Adam J. Smith, pro se, contained no patents with either element so defining of the L.I.S.T. Wick. Said self-searching applicant did find where these two elements are used to a limited degree in completely formed candles, as either decoration outside of the combustion area (an “inclusion candle”), or aromatic additive to the wax or fuel (NPL Cite) No.¹⁰).

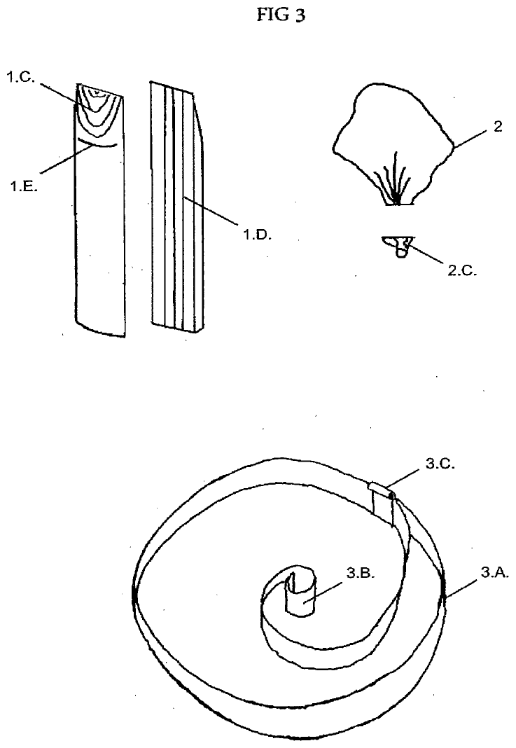

The types of wicks listed, composite (as is the L.I.S.T Wick), or other typed wick, do not so much as even contain the two out of three major components [the fourth and only other component being (FIG. 3): “Means of fixing wood and leaf/flower petal material composition upright and fixed contiguously”].

### SUMMARY

In accordance with one embodiment a candle wick comprises leaf and flower petal material disposed between and contiguous two sides of wood and means for sustaining the composition upright and together.

### BRIEF DESCRIPTION OF DRAWINGS

### Figures

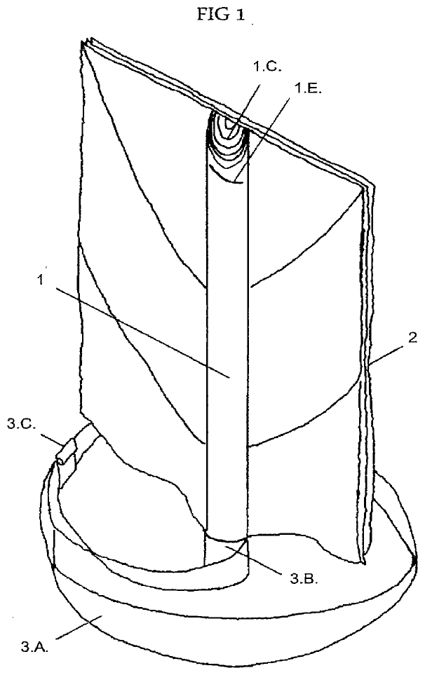

FIG. 1 is a perspective view of the L.I.S.T Wick as it stands alone.

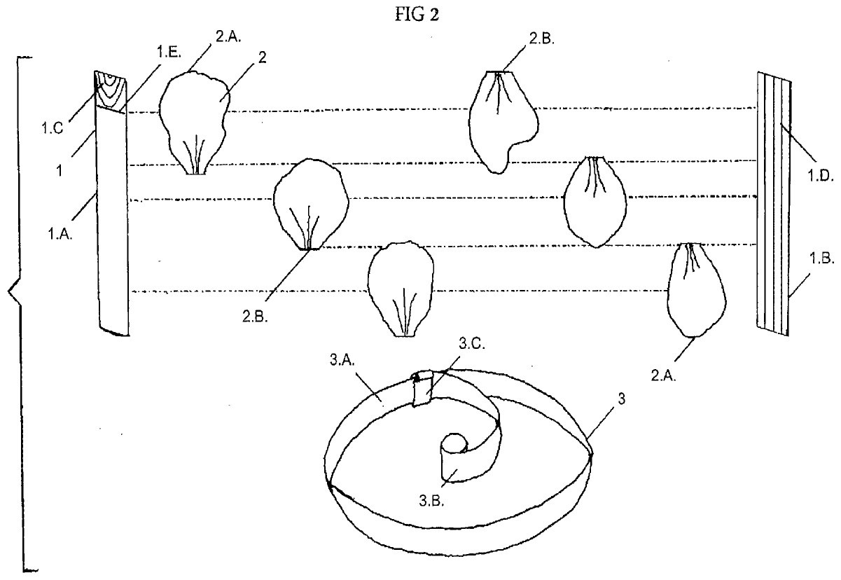

FIG. 2 is an exploded view of the L.I.S.T. Wick.

FIG. 3 is a view of the three components of the L.I.S.T. Wick.

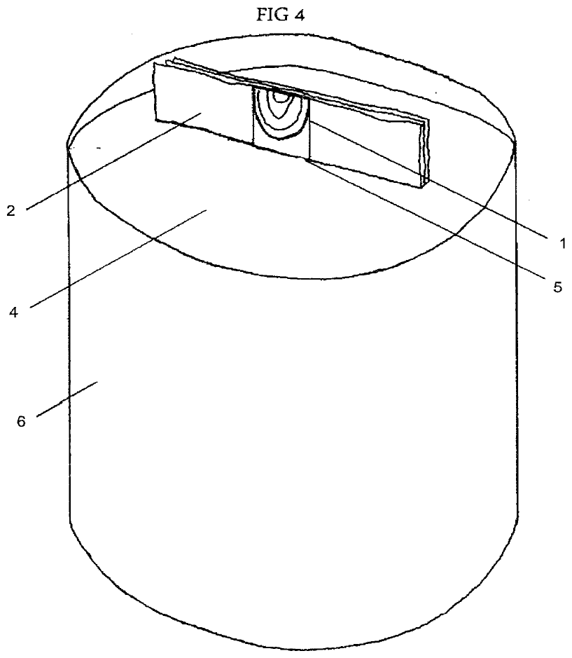

FIG. 4 is a complete candle containing the L.I.S.T. Wick.

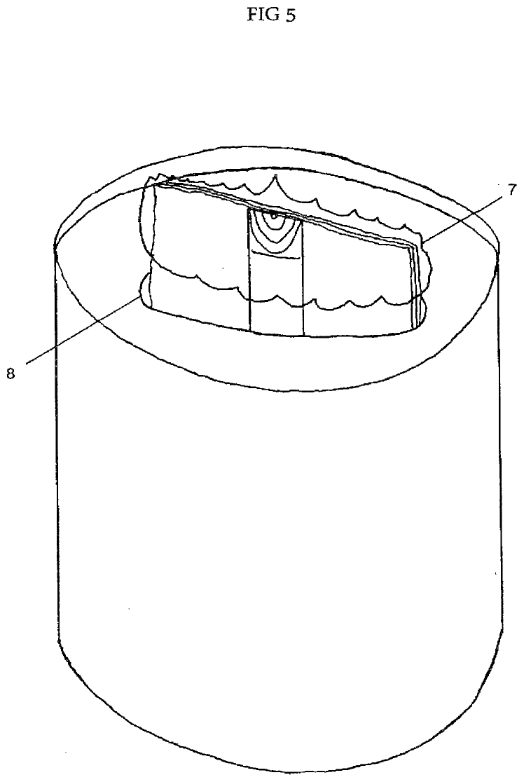

FIG. 5 is a burning candle containing the L.I.S.T. Wick.

### REFERENCE NUMERALS

1. One of two sides of cured wood

A. Left side

B. Right side

C. Planed top of cured wood

D. Interior of wood half

E. Notch (to mark candle pour level)

2. Leaf and flower petal material

A. Top/tip

B. Bottom

C. Bottom tip of flower petal (removed)

3. Means of fixing wood and leaf/flower petal material composition upright and fixed contiguously

A. Aluminum ribbon

B. Gripping portion of wick sustaining stand

C. Buckle component of wick stand (aluminum)

4. Wax or oil (fuel)

5. Wax or oil surface at (5.) Notch-level

6. Candle container

7. Flame

8. Molten wax pool

### DETAILED DESCRIPTION

The Leaf-In-Split-Stick (LIST) Wick can be embodied in several ways. By technical definition for use in prosecuting the patent for the said LIST Wick, it is two halves (or sides) (Nos. 1. A. and 1. B.) of (No. 1.) dried (cured) wood. The two sides of wood grip the middle of at least one (2., 2. A, and 2. B.) dry leaf or flower petal from a plant. (Both wood and leaf or flower petal must be knowingly non-toxic when combusted, or handled.) This composition is held upright and gripped permanently in place by (3.) means of sustaining this position. When the composition is sustained permanently together and in the vertical position as a candle wick, it may be placed in molten Wax or oil, thus, creating a candle (or lamp).

### DETAILED DESCRIPTION—RAMIFICATIONS

One embodiment comprises the two halves of a dried, split-centrally lengthwise, wooden stick, such as from a tree. (The inventor uses the means of a vice-mounted utility blade to perform the stick splitting.) What tree is left to the chandler's discretion, for what effect the wood type will have. The split stick is further cured by removing its bark by whatever means for doing so (scraping, sanding, etc.) The split stick is clamped, both sides fitted back together as before it was split; notched at ¼ A inch (as the National Candle Association recommends for wick height pour-level); and planed on each side of the split to create two angled planes that make the initial candle lighting faster to achieve (as the combustion surface is greater in ratio to the wick's non-combustion interior).

The above embodiment also comprises flower petals and/or leaves from a tree or plant. These are dried in a drying rack, the time required being a matter of days to weeks. At time of production, the flower petals and leaves are soaked in clean water until soft, facilitating ability to rinse off excess soil, as well as softening them whereas they can be handled in assembling the wick without cracking or breaking. After rinsing, they can be fixed between the two sides of the split stick and gripped permanently upright by the means of a stand.

The applicant did invent the above embodiment's stand from aluminum sheet metal, cut in straight ribbon of specific size. The (aluminum) gauge and heft is high enough of both to permit a strong gripping ability of the composition of leaf/flower petal/split stick at its predetermined bottom portion as well as to permit malleability to form the stand, When formed, the top stick and leaf/flower petal composition is squeezed into the gripping portion of aluminum ribbon curled slightly greater around than the above composition. Once gripped securely, the angle of the wick can be slightly adjusted if necessary.

When the above embodiment's wick is fully assembled, split stick securely fixing the middle of leaf and/or flower petal either vertically or inverted, it is further dried to remove the moisture from the aforementioned pre-assembly soaking and rinsing of leaves and/or flower petals. This is most easily achieved by air-drying for approximately twenty-four (24) hours, then placing in a conventional oven at approximately two-hundred-twenty (220) degrees Fahrenheit for approximately forty-five (45) minutes and letting stand until cool in the oven. When cool to touch, the wick is ready to be placed and poured into a candle.

Other embodiments can be wood of any kind cured to suitable status for use. “Planar wicks,” as found in the Cooperative Patent Classification C11C 5/00, could be used, on either side a leaf or petal, pressing it between them to release their fragrance and effect from their burning on air quality. However, there are many poisonous leaves; flower petals; wood types or varieties, and only a verified type or variety is safe to use. Examples of safe varieties of these each are: rose petals, considered edible; the applicant theorizes the leaves from the, “Red Haw” tree, unverified, although the Red Haw leaves have a desirable thickness, shape, and cinnamon-like scent seems released in its use; maple wood as well, releases a pleasant scent. Poison plants can be found in all varieties, flower, tree, or bush; and lists of these can be found in non-patent literature. However, these lists, as extensive as they are also do not nearly recognize all the poison types of plant, bush, or tree. That is why only edible components are desired, if not at least non-toxic.

### Advantages

Made from maple wood as the choice for wood sides to grip said leaf and flower petal material in a fixed, permanently upright position [approximately 90 degrees (right angle) to surface level], by means of sustaining with said sustainer stand, one embodiment inherits aromatherapy. As well, rose, tulip, and daffodil, add luxury. When used with natural wax, according to its purity, the candle produced is a strong air freshener, and seems able to, indeed, purify the air.

A wood cautioned against is pine, or woods containing creosote. Others can be considered poisonous and should never be burned in any way indoors or near humans.

Poison leaves and flowers are also innumerable.

If by its simplicity, novelty or non-obviousness is questioned despite lack of discoverable prior art or patent literature, the need for the following provide for the affirmation of those both qualities, novelty and non-obviousness:

A61L 9/037 Apparatus therefor sterilizing the air, comprising a wick

A47K 13/30 Devices for eliminating smells in the lavatory

B01D 45/00-51/00}
} separating dispersed particles from gases and vapors

B03C 3/00 }

B01D 53/00 chemical or biological purification of waste gases

E03D 9/007 Devices for eliminating smells by diffusing deodorants in lavatories

H04R 1/12 articles having provision for disinfection

F23G 7/06 consuming noxious gases by combustion

### CONCLUSION

“Whole,” is a term: used in conservationism a great deal in the present era. It refers to a product or component that is unprocessed, direct from its source, used in its naturally made state. This of course saves many resources eliminating any more to the production process. The Leaf-In-Split-Stick (or “L.I.S.T.”) Candle Wick is composed of: 1) ‘whole’ leaves or flower petals, 2) whole (cured) wood branches (from trees or woody other plants); and, debatably fitting the definition of, “whole,” 3) the aluminum sustainer stand (75% of all aluminum produced has been recycled since the aluminum industry has been in existence). I should say at least two of the three components for the L.I.S.T Wick are definitely, “whole,” and if the aluminum doesn't fit the description, it is impressive! (Please recycle.)

Therefore, the L.I.S.T. Wick, in a candle made with a plant-based wax, is pure . . . at least to the degree of the wax's purity (the wax being outsourced). In turn, when the candle containing the L.I.S.T. Wick burns, the consumer can expect, as well as anticipate, the purity that is evident from the simple knowledge of the “whole” components.

If a pure flame endures, then what impurity encounters it will be destroyed or impaired, purified from the air. The consumer might find it most refreshing, and its positive effects on health and environment seem many. As well, the L.I.S.T. Wick Candle is aesthetically delightful. Even if eaten (digested internally), the leaves, flower petals, and wood are non-toxic. It is not just a beautiful flame, a peaceful one as well.

### SCOPE

The embodiments mentioned above are broad to narrow, as the invention claimed can embody any size, and shape, feasible to its definition. The Candle Wick is an altogether new kind of wick and candle, like no other in the prior art according to the applicant. It should be limited only by the appended claims and their legal equivalents.

### GLOSSARY

Material: matter or substance from a specified source

Protrusion: a member directed outward from its base

Species: a group of closely related organisms

I claim:

1. A candle wick, comprising:
(A.) a composition of dried whole or unprocessed leaf and flower petal material disposed between
(B.) two sides of cured wood fixed together in a composition vertically by
(C.) means of sustaining said wick permanently upright
(D.) whereby contained within wax or oil said wick functions as a candle.

2. The candle wick of claim 1, wherein:
(A.) the two sides of cured wood consist of a split wooden stick from a tree.

3. The candle wick of claim 1, wherein:
(A.) the two sides of cured wood consist of milled lumber.

4. The candle wick of claim 1, wherein:
(A.) the two sides of cured wood consist of the stem, twig, branch, or other naturally grown protrusion from a plant species.

5. A candle making method comprising the steps:
(A.) two sides of cured wood are fixed
(B.) fixed by means of sustaining upright and pressed against the opposite side of said wood
(C.) fixed and sustained with the material or entirety of dry leaves and flower petals disposed between said two sides of cured wood
(D.) disposed in either wax or oil
(E.) whereby said composition functions as a candle or lamp.

6. The candle wick of claim 5, wherein:
(A.) the two sides of cured wood consist of a split wooden stick from a tree.

7. The candle wick of claim 5, wherein:
(A.) the two sides of cured wood consist of milled lumber.

8. The candle wick of claim 5, wherein:
(A.) the two sides of cured wood consist of the stem, twig, branch, or other naturally grown protrusion from a plant species.

9. A candle wick sustained upright or vertically and disposed within wax or oil characterized in that:
(A.) said wick is composed of cured wood
(B.) said wick is composed of leaf and flower petal material
(C.) said cured wood is sustained compressing the leaf and flower petal material and sustained in the vertical position
(D.) sustained by means of apparatus.

10. The candle wick of claim 9, wherein:
(A.) the two sides of cured wood consist of a split wooden stick from a tree.

11. The candle wick of claim 9, wherein:
(A.) the two sides of cured wood consist of milled lumber.

12. The candle wick of claim 9 wherein:
(A.) the two sides of cured wood consist of the stem, twig, branch, or other naturally grown protrusion from a plant species.
